(19) United States
(12) Patent Application Publication
(10) Pub. No.: US 2016/0356734 A1
(43) Pub. Date: Dec. 8, 2016

(54) NON-DESTRUCTIVE THERMOGRAPHIC WELD INSPECTION

(71) Applicant: EDISON WELDING INSTITUTE, INC., Columbus, OH (US)

(72) Inventors: Jeong K. JA, Centerville, OH (US); Sean GLEESON, Upper Arlington, OH (US)

(21) Appl. No.: 15/241,584

(22) Filed: Aug. 19, 2016

Related U.S. Application Data
(63) Continuation of application No. 13/633,960, filed on Oct. 3, 2012, now abandoned.
(60) Provisional application No. 61/542,942, filed on Oct. 4, 2011.

(51) Int. Cl. G01N 25/72

(52) U.S. Cl. CPC G01N 25/72

(57) ABSTRACT

A non-destructive system for characterizing welds that includes at least one weldment that further includes at least two components joined together a weld; at least one source of heat energy directed toward one side of the weldment, wherein the source of heat energy is operative to direct a predetermined amount of heat energy through the first component toward one side of the weld, through the weld and the area surrounding the weld, and through the second component to the opposite side of the weldment, and wherein the heat energy is sufficient to induce a temperature change in the weld and the area surrounding the weld; and a temperature measuring device directed toward the opposite side of the weldment for gathering temperature data from heat passing through the second component away from the weld and the area surrounding the weld, wherein the gathered temperature data is indicative of weld quality.

### CROSS-REFERENCE TO RELATED APPLICATIONS

This patent application is a continuation of U.S. patent application Ser. No. 13/633,960 filed on Oct. 3, 2012, and entitled “Non-Destructive Thermographic Weld Inspection”, which claimed the benefit of U.S. Provisional Patent Application Ser. No. 61/542,942 filed on Oct. 4, 2011, and entitled “Non-Destructive Thermographic Weld Inspection”, the disclosures of which are hereby incorporated by reference herein in their entirety and made part of the present U.S. utility patent application for all purposes.

### BACKGROUND OF THE INVENTION

The described invention relates in general to weld inspection systems and methodologies and more specifically to a non-destructive system for characterizing weld quality, wherein heat energy is used to induce a measurable temperature change in redefined areas of a weldment, and wherein temperature data gathered from the heated areas of the weldment is used to characterize weld quality.

Non-destructive testing (NDT) includes wide group of analytical techniques used in science and industry to evaluate the properties of a material, component, or system without causing damage to the article being tested. The terms Nondestructive Examination (NDE), Nondestructive Inspection (NDI), and Nondestructive Evaluation (NDE) are also commonly used to describe technologies of this nature. Because NDT does not permanently alter the article being inspected, it is a highly-valuable technique that can save both money and time in product evaluation, troubleshooting, and research.

In various manufacturing processes, the creation of welds is commonly used to join two or more metal surfaces to one another. Because these connections often encounter loads and experience fatigue during product lifetime, the welds may fail if not created properly. For example, the base metal must reach a certain temperature during the welding process, must cool at a specific rate, and must be welded with compatible materials or the joint may not be strong enough to hold the surfaces together, or cracks may form in the weld causing it to fail. The typical welding defects, lack of fusion of the weld to the base metal, cracks or porosity inside the weld, and variations in weld density, could all cause a structure to break or a pipeline to rupture.

In particular, the battery manufacturing industry requires a reliable NDE method for weld condition assessment for various tab materials and welding processes. Currently, no NDE techniques are available throughout the industry that can be used in a production facility that requires real time high speed inspection for all of the parts or components used in batteries. Rather, destructive testing is currently used to check the quality of weldments in terms of mechanical pull strength. This type of testing method is not practical in a production line and can only be done by picking samples from time to time from the parts and components manufactured at the production line. Based on production rate increases due to increasing demand in the battery market and the expectation of longterm reliability of final products, there is an ongoing need for a reliable NDE method that can be used in a full production environment.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first non-destructive system for characterizing welds is provided. This system includes at least one weldment, wherein the weldment further includes at least two components joined together by at least one weld; at least one source of heat energy directed toward one side of the weldment, wherein the at least one source of heat energy is operative to direct a predetermined amount of heat energy through the first component toward one side of the weld, through the weld and the area surrounding the weld, and through the second component to the opposite side of the weldment, and wherein the heat energy is sufficient to induce a temperature change in the weld and the area surrounding the weld; and temperature measuring device directed toward the opposite side of the weldment for gathering temperature data from heat passing through the second component away from the weld and the area surrounding the weld, wherein the gathered temperature data is indicative of weld quality.

In accordance with another aspect of the present invention, a second non-destructive system for characterizing welds is provided is provided. This system includes at least one weldment, wherein the weldment further includes at least two components joined together by at least one weld; at least one source of heat energy directed toward one side of the weldment, wherein the at least one source of heat energy is operative to direct a predetermined amount of heat energy through the first component toward one side of the weld, through the weld and the area surrounding the weld, and through the second component to the opposite side of the weldment, and wherein the heat energy is sufficient to induce a temperature change in the weld and the area surrounding the weld; a temperature measuring device directed toward the opposite side of the weldment for gathering temperature data from heat passing through the second component away from the weld and the area surrounding the weld, wherein the gathered temperature data is indicative of weld quality; and a data processor in communication with the temperature measuring device for correlating the temperature data with mechanical pull strength for further characterizing weld quality.

In yet another aspect of this invention, a third non-destructive system and method for characterizing welds is provided is provided. This system includes at least one weldment, wherein the weldment further includes at least two components joined together by at least one weld, and wherein the at least two components further include metal plates; at least one source of heat energy directed toward one side of the weldment, wherein the at least one source of heat energy is a high power, air-coupled heat generating device, wherein the high power, air-coupled heat generating device is operative to direct a predetermined amount of heat energy through the first component toward one side of the weld, through the weld and the area surrounding the weld, and through the second component to the opposite side of the weldment, and wherein the heat energy is sufficient to induce a temperature change in the weld and the area surrounding the weld; a temperature measuring device directed toward the opposite side of the weldment for gathering temperature data from heat passing through the second component away from the weld and the area surrounding the weld, wherein the gathered temperature data is indicative of weld quality; and a data processor in communication with the temperature measuring device for correlating the temperature data with mechanical pull strength for further characterizing weld quality, wherein the data processor is a computer.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a schematic illustration of a good weld condition, wherein the weld conducts heat better through the weld nugget and the surrounding area tightly in contact;

FIG. 2 is a schematic illustration of a poor weld condition, wherein heat is transferred less effectively through the smaller nugget and the surrounding interface that is loosely in contact; and

FIG. 3 is a graph illustrating heat conductibility data for three welded specimens having three different mechanical pull strengths showing different heating rates and peak temperatures when the welded area is exposed to a heat source for a short period of time.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to NDE inspection techniques and more specifically to an inspection methodology for making a quantitative assessment of different types of solid state, laser, ultrasonic, fillet and other types of weld joints where nondestructive weld condition characterization is preferred over destructive testing methods. Currently, welds of this nature rely on a destructive test and sample statistics to qualify a product. The present invention provides a NDE method that eliminates the short falls and limitations of sample based statistics by inspecting all welds while eliminating destructive testing. The non-contact thermographic method of this invention is fast and can easily be automated as a real time inspection system in a production environment. This process has been proven to distinguish between welds of different qualities and mechanical strengths through the development of a system in which a thermal energy is quickly passed through the weld zone and its surrounding area. The real time temperature data of the weld is captured, recorded and an assessment is made to the quality of the weld. This process characterizes welds in situations where fast and accurate inspection is required for process and quality control.

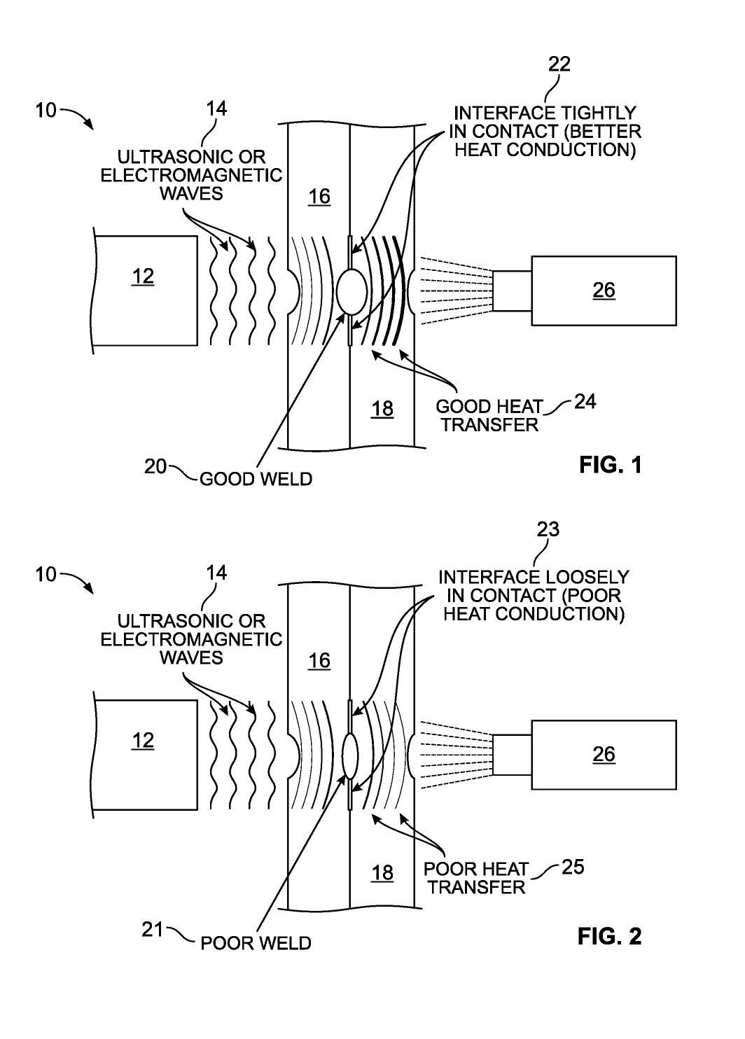

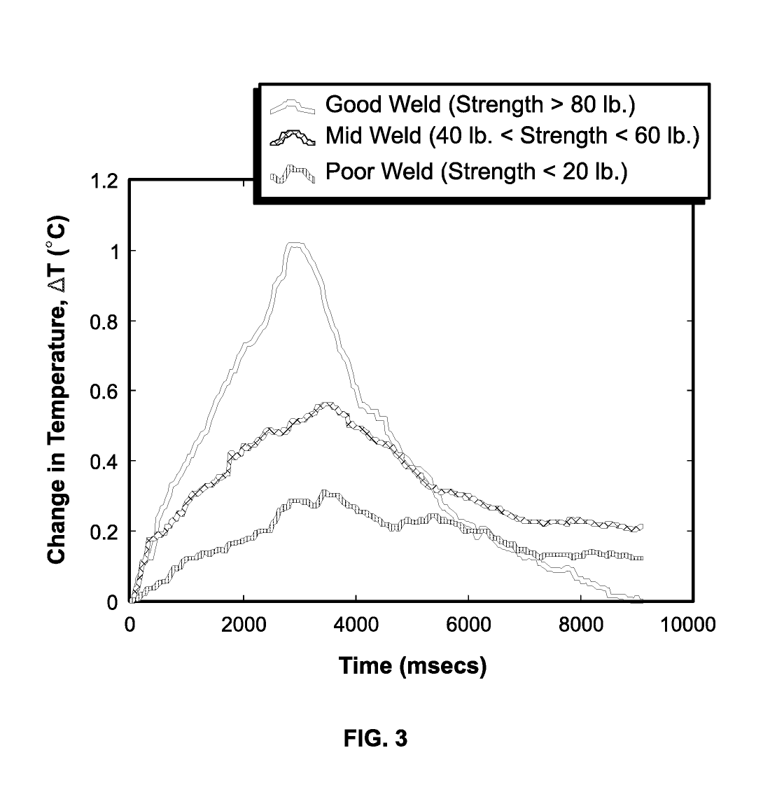

In the broadest sense, a weld inspection system according to the present invention includes a high power, air-coupled heat generating device and a temperature measuring device that tracks the changes in the thermal variations of a welded part. When a through transmission technique is used, parts with good welds show a rapid temperature rise upon ultrasonic wave excitation while poor welds show a more modest temperature change. As shown in FIGS. 1-2, inspection system 10 includes a heat energy source 12 such as an ultrasonic horn or pulse laser that directs ultrasonic or electromagnetic waves 14 through a first part or component 16 that has been joined to a second part or component 18 by at least one weld 20. A good weld such as that shown in FIG. 1 creates a tight interface 22 between first and second components 16 and 18, resulting in characteristically good heat transfer 24 through second component 18. A poor weld such as that shown in FIG. 2 creates a loose interface 22 between first and second components 16 and 18, resulting in characteristically poor heat transfer 24 through second component 18. In both cases, the transferred heat is measured by temperature measuring device 26 and the temperature data can be correlated using a computer, data processor, or other electronic or manual means to mechanical pull strength, which indirectly determines the weld condition of a part (see FIG. 3). A good weld with high mechanical pull strength gives a faster heating rate with a higher peak temperature, while a bad weld with low mechanical pull strength gives a slower heating rate with a lower peak temperature. A weld with intermediate mechanical pull strength gives a heating rate and peak temperature somewhere between good and bad weld conditions. The differences among the three weld conditions used for this illustration are the differences in the mechanical pull strength for each case. The pull strength of the good weld, for example, is estimated to exceed more than 80 pounds, 40 to 60 pounds for the medium weld, and less than 20 pounds for the poor weld.

The amount of heat conductibility through the weld and the surrounding area around the weld depends on the input energy induced by a heat source (e.g., an air-coupled high power ultrasonic device). The input energy can be controlled by the duration of activation time, the output power of the source, the distance between the source device and the article, or the combination of all three factors. A predetermined amount of energy is used so that the article being assessed is not over or under exposed to heat. When too much energy is used, the heat passes through the weld and the surrounding area quickly saturates the entire volume and the temperature difference between a good weld and a bad weld becomes small. When too little energy is used, the additional heat conductibility at the surrounding area is not significant enough to distinguish the difference between a good weld and a bad weld. Material types, thicknesses and welding processes determine the right amount of heat to be used for this system. The surface area that the temperature measuring device covers is another important parameter with regard to obtaining useful temperature data. The area over which the average temperature reading is made should be large enough to cover the weld and the surrounding area. Too large area may diminish the effect of temperature conductibility caused by the weld and surrounding area, while too small area may reduce the contribution from the surrounding area.

Advantages of the present invention include: (i) real time inspection of various types of welds on solid plates; (ii) high speed non-contact inspection for 100% parts inspection; and (iii) elimination of destructive testing and sampling methods. Potential users of this invention include battery manufacturers and other industries using welded solid plates as quality critical parts or components in the final products (e.g., resistance spot welds on the connector tabs of solar panels).

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A non-destructive system for characterizing welds, comprising:
(a) at least one weldment, wherein the weldment further includes at least two components joined together by at least one weld;
(b) at least one source of heat energy directed toward one side of the weldment, wherein the at least one source of heat energy is operative to direct a predetermined amount of heat energy through the first component toward one side of the weld, through the weld and the area surrounding the weld, and through the second component to the opposite side of the weldment, and wherein the heat energy is sufficient to induce a temperature change in the weld and the area surrounding the weld; and
(c) a temperature measuring device directed toward the opposite side of the weldment for gathering temperature data from heat passing through the second component away from the weld and the area surrounding the weld, wherein the gathered temperature data is indicative of weld quality.

2) The system of claim 1, further comprising a data processor in communication with the temperature measuring device for correlating the temperature data with mechanical pull strength for further characterizing weld quality.

3) The system of claim 2, wherein a mechanical pull strength of greater than about 80 pounds represents a weld of good quality; wherein a mechanical pull strength of about 40-60 pounds represents a weld of moderate quality; and wherein a mechanical pull strength of less than about 20 pounds represents a weld of poor quality.

4) The system of claim 1, wherein the at least two components further include metal plates.

5) The system of claim 1, wherein the at least one source of heat energy is a high power, air-coupled heat generating device.

6) The system of claim 1, wherein the at least one source of heat energy is an ultrasonic horn.

7) The system of claim 1, wherein the at least one source of heat energy is a pulse laser.

8) The system of claim 1, wherein the input energy of the at least one heat energy source is controlled by duration of activation time, output power of the heat energy source, distance between the heat energy source device and the weldment, or a combination thereof.

9) A non-destructive system for characterizing welds, comprising:
(a) at least one weldment, wherein the weldment further includes at least two components joined together by at least one weld;
(b) at least one source of heat energy directed toward one side of the weldment, wherein the at least one source of heat energy is operative to direct a predetermined amount of heat energy through the first component toward one side of the weld, through the weld and the area surrounding the weld, and through the second component to the opposite side of the weldment, and wherein the heat energy is sufficient to induce a temperature change in the weld and the area surrounding the weld;
(c) a temperature measuring device directed toward the opposite side of the weldment for gathering temperature data from heat passing through the second component away from the weld and the area surrounding the weld, wherein the gathered temperature data is indicative of weld quality; and
(d) a data processor in communication with the temperature measuring device for correlating the temperature data with mechanical pull strength for further characterizing weld quality.

10) The system of claim 9, wherein a mechanical pull strength of greater than about 80 pounds represents a weld of good quality; wherein a mechanical pull strength of about 40-60 pounds represents a weld of moderate quality; and wherein a mechanical pull strength of less than about 20 pounds represents a weld of poor quality.

11) The system of claim 9, wherein the at least two components further include metal plates.

12) The system of claim 9, wherein the at least one source of heat energy is a high power, air-coupled heat generating device.

13) The system of claim 9, wherein the at least one source of heat energy is an ultrasonic horn.

14) The system of claim 9, wherein the at least one source of heat energy is a pulse laser.

15) The system of claim 9, wherein the input energy of the at least one heat energy source is controlled by duration of activation time, output power of the heat energy source, distance between the heat energy source device and the weldment, or a combination thereof.

16) A non-destructive system for characterizing welds, comprising:
(a) at least one weldment, wherein the weldment further includes at least two components joined together by at least one weld, and wherein the at least two components further include metal plates;
(b) at least one source of heat energy directed toward one side of the weldment, wherein the at least one source of heat energy is a high power, air-coupled heat generating device, wherein the high power, air-coupled heat generating device is operative to direct a predetermined amount of heat energy through the first component toward one side of the weld, through the weld and the area surrounding the weld, and through the second component to the opposite side of the weldment, and wherein the heat energy is sufficient to induce a temperature change in the weld and the area surrounding the weld;
(c) a temperature measuring device directed toward the opposite side of the weldment for gathering temperature data from heat passing through the second component away from the weld and the area surrounding the weld, wherein the gathered temperature data is indicative of weld quality; and
(d) a data processor in communication with the temperature measuring device for correlating the temperature data with mechanical pull strength for further characterizing weld quality, wherein the data processor is a computer.

17) The system of claim 16, wherein a mechanical pull strength of greater than about 80 pounds represents a weld of good quality; wherein a mechanical pull strength of about 40-60 pounds represents a weld of moderate quality; and wherein a mechanical pull strength of less than about 20 pounds represents a weld of poor quality.

18) The system of claim 16, wherein the at least one source of heat energy is an ultrasonic horn.

19) The system of claim 16, wherein the at least one source of heat energy is a pulse laser.

20) The system of claim 16, wherein the input energy of the at least one heat energy source is controlled by duration of activation time, output power of the heat energy source, distance between the heat energy source device and the weldment, or a combination thereof.
